(19) United States
(12) Patent Application Publication
(10) Pub. No.: US 2014/0222917 A1
(43) Pub. Date: Aug. 7, 2014

(54) Sharable Reference to Shared Content in a Cloud Storage

(71) Applicant: ID Fusion Software Inc., Winnipeg (CA)

(72) Inventor: Dave Poirier, Winnipeg (CA)

(21) Appl. No.: 14/169,261

(22) Filed: Jan. 31, 2014

Related U.S. Application Data
(60) Provisional application No. 61/759,809, filed on Feb. 1, 2013.

(51) Int. Cl. H04L 29/06

(52) U.S. Cl. CPC H04L 65/403
USPC 709/204

(57) ABSTRACT

Clickable links are created and shared between collaborators sharing files to quickly refer to a specific file or folder, without having to transfer or bundle the actual file or folder. The links created are location agnostic; they can be used by any of the members regardless of where the shared files are located on their own device.

### FIELD OF THE INVENTION

The present invention relates to generating and/or using a reference link to a shared file or folder which is sharable among different users having shared access to the shared file or folder on a cloud storage system, and more particularly, the present invention relates to a unique configuration of the reference link to the shared file or folder using an identification of the root folder commonly shared by the different users and a relative path from the root folder identification to the shared file or folder.

### BACKGROUND

Electronic device users participating in a common project often have to share files with each other. When communicating amongst each other they often have to refer another user to a specific file containing pertinent information. The process of referring a user to a file involves either attaching the actual file to the communication or manually entering sufficient information to describe where the file is stored: a process usually done by manually entering a list of folders and finally the filename of the file(s).

When using advanced file-sharing services such as Dropbox, the base location where all the shared folders will be stored can be different from one device to the next (as specified by the user); hence a full path that would be valid on one machine may not be valid on another.

### SUMMARY OF THE INVENTION

The present invention relates to the use of sharable reference links described herein as “dropclips”, which allow users of electronic devices to quickly refer to specific shared files or folders.

Using a standard URI format, users can quickly generate a clickable link that can be pasted into an email client or some other communication medium, to other users of a shared folder in order to provide easy access to a specified document or folder.

The invention was originally developed to work with Dropbox and can be applied to any number of file sharing services. It consists in inferring a unique identifier for the root of the shared folder and the relative path of the file to the root of the shared folder, compiling the information into a clickable URI then reversing the process on the receiver's end when the link is clicked.

It differs from the currently available Dropbox services by not requiring the user to have access to the public Internet in order to link a file in a private shared folder; and it also differs by not requiring the user to download a new copy of a file from the public Internet by pointing the user to the file that is already in his local copy of a shared Dropbox folder.

According to one aspect of the invention there is provided a method to generate a unique reference from any electronic devices having access to shared electronic file storages or local copies of the shared electronic storages; regardless of the communication status of said devices.

According to another aspect of the present invention there is provided a pre-defined format to store the reference link generated according to the present invention with a representation compatible to RFC 3986 (http://tools.ietf.org/html/rfc3986); consisting of a “dropclip” scheme, an empty authority, and a path consisting of a unique electronic storage identifier representing the shared electronic storage, and a relative path of the file or folder in reference to the root of the said shared electronic storage.

According to another aspect of the present invention, there is provided a pre-defined format to store the reference link generated according to the present invention with a representation compatible to RFC 3986 (http://tools.ietf.org/html/rfc3986); consisting of a “http” scheme, with a domain name identifier, both locally and globally resolved, with or without a port number, and a path consisting of a unique electronic storage identifier representing the shared electronic storage, and a relative path of the file or folder in reference to the root of the said shared electronic storage; such that said link can be opened by a regular web browser.

According to another aspect of the present invention there is provided a method by which any electronic device can infer the complete file system path to a file or folder from a reference provided the said device has access to the shared electronic storage, or a local copy of the said shared electronic storage, from which the reference was generated regardless of the current or past communication status of any of the devices and regardless of the synchronization status of the electronic storage.

According to another aspect of the present invention there is provided a specific implementation consisting of generating a unique reference to a file or folder stored in a shared Dropbox folder; by inferring a unique shared electronic storage identifier for the Dropbox folder and determining the relative path of the file or folder from the root of the Dropbox folder; regardless of the public/private status of the Dropbox folder, and regardless of the online status of the electronic device generating the reference.

According to another aspect of the present invention there is provided a specific implementation consisting of inferring the Dropbox folder matching the unique electronic storage identifier from the reference, then inferring the complete file system path by appending the relative path of the file or folder in the reference to the path of the identified Dropbox folder on the electronic device interpreting the reference; regardless of the online status of any of the electronic devices or of the public/private status of the Dropbox folder.

According to another aspect of the present invention there is provided a method of generating a reference link by a first user using a first computer device for subsequent use by a second user using a second computer device to access a shared item within a shared storage which has shared accessibility by the first and second users on a cloud storage system, the method comprising:

identifying the shared item to be designated by the reference link;

identifying an electronic identifier of a root of the shared storage common to the first and second users within which the shared item is located;

identifying a relative path of the shared item relative to the root of the shared storage; and

assembling said electronic identifier and said relative path into the reference link such that reference link is usable to navigate the second user on the second computer device to the shared item.

According to a second aspect of the present invention there is provided a reference link arranged to be generated by a first user using a first computer device for subsequent use by a second user using a second computer device to access a shared item within a shared storage on a cloud storage system in which the shared storage has shared accessibility by the first and second users, the reference link comprising:

an electronic identifier of a root of the shared storage common to the first and second users within which the shared item is located; and

a relative path of the shared item relative to the root of the shared storage;

wherein said electronic identifier and said relative path are integrated with one another to define a common link which is operable to navigate the second user on the second computer device to the shared item.

According to a third aspect of the present invention there is provided a method of navigating a second user using a second computer device to a shared item within a shared storage on a cloud storage system in which the shared storage has shared accessibility by a first user using a first computer device and the second user using the second computer device, the method comprising:

providing a reference link from the first user using the first computer device in which the reference link comprises i) an electronic identifier of a root of the shared storage common to the first and second users within which the shared item is located, and ii) a relative path of the shared item relative to the root of the shared storage, wherein said electronic identifier and said relative path are integrated with one another to commonly define the reference link; and

following the reference link on the second computer device such that the second user is directed to the shared item.

One exemplary embodiment of the invention will now be described in conjunction with the accompanying drawings in which:

### BRIEF DESCRIPTION OF THE DRAWINGS

FIG. 1 is a drawing showing a typical process of generating and consuming a DropClip link;

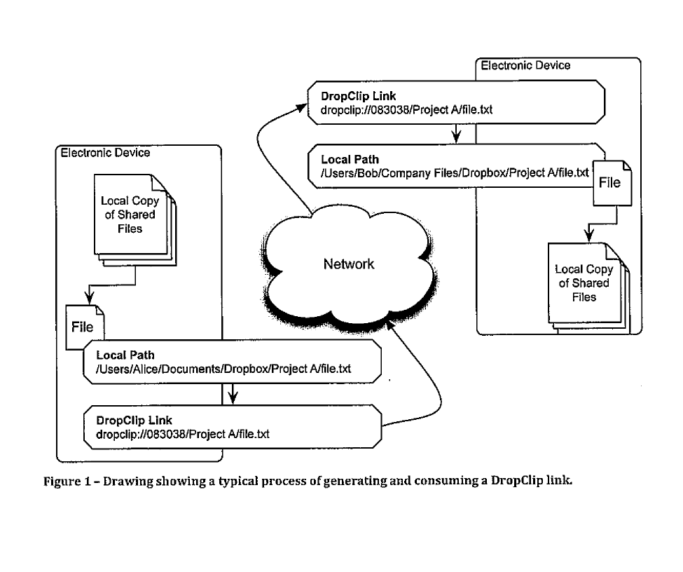

FIG. 2 is a flow chart illustrating the DropClip link generation logical procedure, under Mac OSX; and

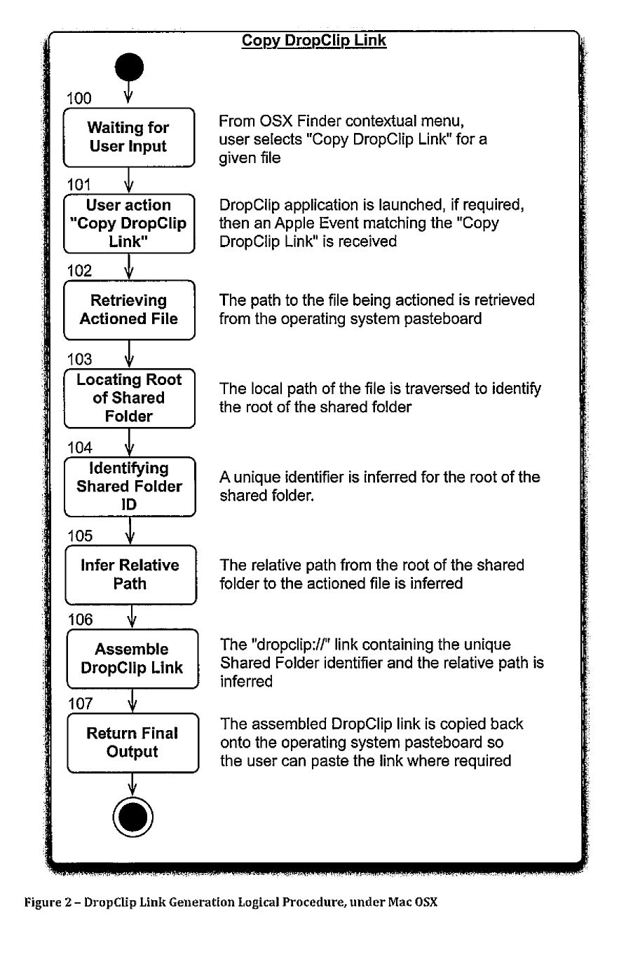

FIG. 3 is a flow chart illustrating the DropClip link usage logical procedure, under Mac OSX.

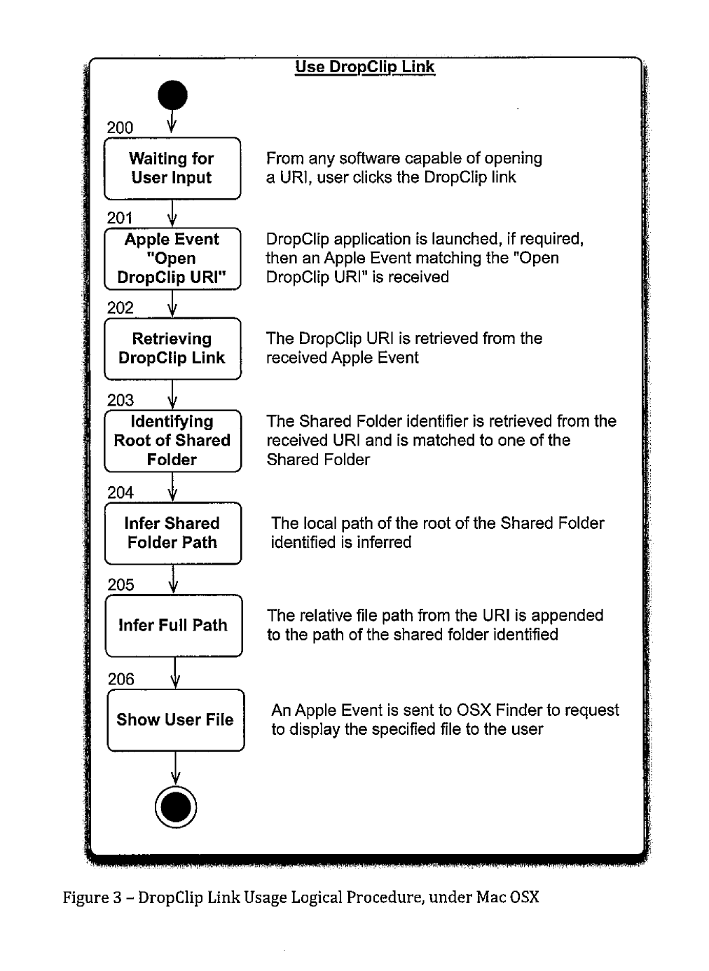

### DETAILED DESCRIPTION

Referring to the drawings included in this patent, the logical procedures and the specific implementation for Dropbox under Mac OSX will be described.

### Definitions

Base64: Common data encoding scheme used widely on the Internet; described in RFC 4648 (https://tools.ietf.org/html/rfc4648).

Dropbox: Software utility and online service for sharing files via the public Internet (https://www.dropbox.com).

DropClip Link: The subject of this patent, also referred to as dropclip(s) and/or DropClip(s).

Electronic Device: Device capable of storing digital information and able to receive and transmit information over a digital network.

File: Digital document, usually containing information pertinent to a single subject.

Filename: Name given to a file to uniquely identify it amongst other files stored in a folder.

File System: Pre-defined method of organizing, storing and retrieving digital information, usually represented by files and folders, stored on an electronic device.

Folder: Location within a file system containing one or more files and folders.

Local Path: Complete list of all the file system folders that have to be traversed in order to uniquely identify a single file or folder stored on an electronic device.

Mac OSX: The primary operating system developed by Apple Inc. to be used by their desktop and laptop computers; unless otherwise specified reference to Mac OSX in this document includes but are not limited to versions 10.6, 10.7 and 10.8.

Network: A digital communication network allowing one or multiple electronic devices to communicate to other electronic devices; includes but is not limited to the public Internet.

Objective-C: Computer software programming language primarily used to develop Mac OSX applications.

Pasteboard: Mac OSX service allowing the exchange of data between applications, often used to copy and paste information in various applications.

Shared Files: Group of files and folders accessible in a central location over a network or locally synchronized from one or more devices via a network.

URI: Abbreviation for “Uniform Resource Identifier” as described in RFC 3986 (http://tools.ietf.org/html/rfc3986)

### Copy DropClip Link

Generally, a DropClip software utility is extending the contextual menu of the file navigation of the operating system; allowing a user to quickly access the extended services [100]. Under Mac OSX, this is achieved by describing “services” provided by the software utility in its application bundle; this description includes a name, an Objective-C method and the types of documents to which that service should be extended to.

When a user activates the associated contextual menu option and triggers the “Copy DropClip Link” service [101], the DropClip software utility will be launched (if it is not already running) and indicated to perform the service requested. Under Mac OSX, this triggers the “getDropclipURL” method. At which point our Objective-C implementation can then perform various actions.

The path of the file or folder for which the service was requested is retrieved [102]. Under Mac OSX the path of the file is stored in a pasteboard provided as argument to our service method. The Objective-C implementation communicates to the pasteboard to retrieve the path to the file or folder then verifies that the file or folder in question exists in the file system.

The path of the file or folder, once retrieved, is traversed one parent folder at a time until a shared folder is identified [103]. Under Mac OSX, when the shared folder is a Dropbox folder, the folder itself will contain a “.dropbox” hidden file.

Once the shared folder has been located, the unique identifier for that folder is inferred [104]. Under Mac OSX, the Dropbox shared folders store their unique identifiers in the “.dropbox” hidden file; the identifier is read from the file, recorded as the unique shared folder identifier and encoded for inclusion in the link at a later stage.

The relative path of the file or folder (for which the service was initially requested) to the shared folder identified is inferred [105]. Under Mac OSX, this is equivalent to removing from the full path the leftmost portion of the path that matches the path of the identified shared folder; the remaining path is recorded as the relative path and encoded for inclusion in the link at a later stage.

With the unique shared folder identifier and the relative path, the DropClip link is assembled [106]. The DropClip link is first a concatenation of the “dropclip” URI system prefix, followed by the encoded unique shared folder identifier and the relative path of the file or folder.

Once the link is assembled, it is made available to other applications [107]. Under Mac OSX, the link is returned in multiple formats to the “general” pasteboard: allowing the user to paste the link into other computer software applications.

At this stage, the user can freely paste the DropClip link into a variety of computer software applications or documents. The DropClip link can be forwarded to other users as part of an email, be imbedded into a document or otherwise transmitted to other users. Only the link itself needs to be transferred; the file content, being already present in the shared folder, does not require to be transmitted to the recipient.

### Use DropClip Link

Modern operating systems allow an installed software application to register URI systems to be handled by the application. The DropClip software utility registers the “dropclip” URI system; which will forward the user requests to open DropClip link to the DropClip software utility.

When a user clicks on a DropClip link, the operating system identifies the request to be for the “dropclip” URI system and forwards an “open URI” request to the DropClip software utility [200].

The DropClip software utility is launched, if required, then sent an event requesting to open the URI [201]. Under Mac OSX, application desiring to handle open URI request need to register an Objective-C method to be called for open URI requests. As the user clicks on the DropClip link, the “handleDropclipURL” method in the DropClip software utility gets called.

The DropClip URI is recorded from the event received [202]. Under Mac OSX, the open URI (kAEGetURL) method called receives an Apple Event, among which a “keyDirectObject” will provide a string containing the URI to open.

Once the URI is recorded, before we can identify the shared folder associated to the request DropClip needs to identify the locations where shared folders are located [203]. Under our current Mac OSX implementation for Dropbox, that location is contained in a “host.db” file stored in a “.dropbox” configuration folder inside the user's home directory. The file system path to the root of all Dropbox shared folder is Base64 decoded from the “host.db” configuration file.

Generally speaking, the DropClip software utility could maintain its own configuration file pointing to the various local file system paths where shared folders are located.

With the location of all the shared folders known, the unique shared folder identifier is retrieved from the DropClip URI and matched against the identifiers found for each folder until a match is found [204] and its local path recorded. Under Mac OSX with Dropbox, this process involves reading the unique identifiers from the “.dropbox” file found in all the folders located in the Dropbox root folder. Once the matching folder is identified, the local path of the shared folder is recorded.

Once the matching shared folder has been located, the relative path to the file or folder contained in the URI is appended to the path of the shared folder [205].

The DropClip software utility attempts to verify that the file at the re-assembled path exists and identify whether it is a folder or a file [206], in either case it ask the operating system file navigator to select the file or folder and display the selection to the user. Under Mac OSX, this is achieved by sending an Apple Event to the shared workspace asking to select a specific file or to display the content of a given folder in a new Finder window.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of generating a reference link by a first user using a first computer device for subsequent use by a second user using a second computer device to access a shared item within a shared storage which has shared accessibility by the first and second users on a cloud storage system, the method comprising:
identifying the shared item to be designated by the reference link;
identifying an electronic identifier of a root of the shared storage common to the first and second users within which the shared item is located;
identifying a relative path of the shared item relative to the root of the shared storage; and
assembling said electronic identifier and said relative path into the reference link such that the reference link is usable to navigate the second user using the second computer device to the shared item.

2. The method according to claim 1 including identifying said electronic identifier and said relative path using a local copy of the shared item located on the first computer device regardless of a communication status of the first computer device.

3. The method according to claim 1 including assembling said electronic identifier and said relative path into the reference link such that the reference link is usable to navigate the second user to a local copy of the shared item on the second computer device regardless of a communication status of the second computer device.

4. The method according to claim 1 assembling said electronic identifier and said relative path into the reference link such that the reference link is in a pastable format arranged to be copied and pasted between different applications.

5. The method according to claim 1 including identifying said electronic identifier by:
i) identifying a full path of the shared item on the first computer device;
ii) traversing parent folders of the full path until a shared folder is identified; and
iii) identifying an electronic identifier of the cloud storage system which is associated with the shared folder.

6. The method according to claim 5 including identifying said relative path as a remainder of said full path of the shared item on the first computer device from the shared folder to the shared item.

7. The method according to claim 5 including identifying the shared folder by locating a hidden file associated with the cloud storage system which is stored within the shared folder.

8. The method according to claim 1 including generating a unique reference to a file or folder stored in a shared Dropbox folder by inferring a unique shared electronic storage identifier for the Dropbox folder determining the relative path of the file or folder from the root of the Dropbox folder, regardless of the public/private status of the Dropbox folder and regardless of the online status of the electronic device generating the reference.

9. The method according to claim 1 including inferring the Dropbox folder matching the unique electronic storage identifier from the reference, then inferring the complete file system path by appending the relative path of the file or folder in the reference to the path of the identified Dropbox folder on the electronic device interpreting the reference; regardless of the online status of any of the electronic devices or of the public/private status of the Dropbox folder.

10. The method according to claim 1 wherein the reference link is stored in a pre-defined format with a representation compatible to RFC 3986, consisting of a dropclip scheme, an empty authority, and a path consisting of said electronic identifier of the shared storage and said relative path of the shared item.

11. The method according to claim 1 wherein the reference link is stored in a pre-defined format with a representation compatible to RFC 3986; consisting of a “http” scheme, with a domain name identifier, both locally and globally resolved, with or without a port number, and a path consisting of said electronic identifier of the shared storage and said relative path of the shared item.

12. A reference link arranged to be generated by a first user using a first computer device for subsequent use by a second user using a second computer device to access a shared item within a shared storage on a cloud storage system in which the shared storage has shared accessibility by the first and second users, the reference link comprising:
an electronic identifier of a root of the shared storage common to the first and second users within which the shared item is located; and
a relative path of the shared item relative to the root of the shared storage;
wherein said electronic identifier and said relative path are integrated with one another to define a common link which is operable to navigate the second user on the second computer device to the shared item.

13. A method of navigating a second user using a second computer device to a shared item within a shared storage on a cloud storage system in which the shared storage has shared accessibility by a first user using a first computer device and the second user using the second computer device, the method comprising:
providing a reference link from the first user using the first computer device in which the reference link comprises i) an electronic identifier of a root of the shared storage common to the first and second users within which the shared item is located, and ii) a relative path of the shared item relative to the root of the shared storage, wherein said electronic identifier and said relative path are integrated with one another to commonly define the reference link; and
following the reference link on the second computer device such that the second user is directed to the shared item.
